(19) United States
(12) Patent Application Publication
(10) Pub. No.: US 2014/0180818 A1
(43) Pub. Date: Jun. 26, 2014

(54) SYSTEM AND METHOD FOR STREAMING CUSTOMIZED COMMERCIAL RADIO-STYLE BROADCASTS TO BUSINESS ESTABLISHMENTS

(71) Applicant: CUSTOM RADIO NETWORK, INC, Santa Monica, CA (US)

(72) Inventors: John MISTLER, MARINA DEL REY, CA (US); Henry MECKE, LOS ANGELES, CA (US)

(73) Assignee: CUSTOM RADIO NETWORK, INC., SANTA MONICA, CA (US)

(21) Appl. No.: 13/722,966

(22) Filed: Dec. 20, 2012

(51) Int. Cl. G06Q 30/02

(52) U.S. Cl. CPC G06Q 30/0259
USPC 705/14.57

(57) ABSTRACT

A system and method for delivering customized audio streams to business establishments are described. Business establishment are provided with live, commercial radio-style programmed audio streams, with interstitial elements produced and custom tailored to support the branding, atmospheric, energetic, and promotional needs of each business, while generating revenue from outside advertisers and sponsors.

### FIELD

The present disclosure generally relates to a system and method for delivering customized audio streams to business establishments. More specifically, the present disclosure relates to a system and method for designing and producing custom audio content for groups of business establishments from a plurality of production locations, organizing that audio content at a central location into live audio streams, and delivering those streams to the corresponding business establishment locations for broadcast and audible playback.

### BACKGROUND

Commercial FM radio broadcasting began in 1939 and within ten years had established the concept of the “radio personality,” or “disc jockey” (DJ). A distinct programming format arose and embedded itself in the public's understanding of what “listening to the radio” meant. This format would include songs, discussion of those songs and relevant topics by a familiar radio personality, along with various “interstitial” elements such as commercials, jingles, promos, sweepers, news, sports, station ids, phone interviews and the like. The public began to identify with these radio personalities, and found itself being influenced by the personalities' opinions. Advertisers recognized the value of having their messages appear alongside the music and discussion, and began purchasing air time.

During that era, the concept of a “background music service” was established with the first successful transmission of music over power lines by the Muzak Company. The company offered research to show that specific kinds of music could increase productivity of workers and product sales. Muzak developed what became known as “elevator music,” named after the generic recordings of popular songs that would emanate from the ceiling in elevators. The method of transmission progressed to telephone lines, then to FM radio subcarriers, then to satellite. These transmission methods, while effective for transmitting high quality audio, carry a very high cost per audio channel transmitted.

With the advent of the Internet came a brand new method of transmitting digital audio signals, and this “streaming” digital packet technology drove the cost of transmission per audio channel down enormously. Coupled with “compression” techniques, which reduce the amount of digital data contained in the digital packets while maintaining quality, both streaming audio and video became ubiquitous on the Internet. Services sprang up in droves utilizing this streaming technology for a myriad of purposes; e.g., Live365® as a hub for individuals using home computers to create their own radio stations and stream them to the world, Pandora® as a personalized music streaming service geared towards individuals, YouTube® as a hub for individuals to make their personal videos available to the world, and so on.

The Internet birthed a new phenomenon in that individual users, sitting in front of personal computer screens, could now choose what content they wanted to view or listen to on their own time. This spawned new possibilities for marketing targeted at specific demographics and individual tastes. Web sites such as Google®, Facebook®, and countless others developed strategies for gathering information on individual users' demographics, preferences, browsing history, etc. and using that information to tailor commercials to those individuals as they browsed the Internet. Pandora gathers information about individuals' preferences in music and uses that information to select specific commercials to insert into each user's audio stream. This kind of targeted advertising increases the probability that the user will purchase the good or service, since it is more likely to be something that the user is interested in.

### SUMMARY

All of the existing services mentioned heretofore provide particular outlets for advertisers, but none of them utilize business establishments as targets for point-of-purchase audio marketing through the commercial FM radio programming format. What is missing is a service that business establishments can subscribe to that will generate commercial radio-style programmed audio streams, with interstitial elements produced and custom tailored to support branding, atmospheric, energetic, and promotional needs of each business, while generating revenue from outside advertisers and sponsors.

According to a first aspect of the present disclosure, a system includes a data storage system and a server system. The data stores at least a first and a second radio commercial. The server system is configured to: retrieve the first and the second radio commercials from the data storage system, generate a customized first playlist comprising the first radio commercial and one or more songs, the customized first playlist explicitly tailored for a first business subscriber, generate a customized second playlist comprising the second radio commercial and one or more songs, the customized second playlist explicitly tailored for a second business subscriber, transmit, through a network, to at least one business location of the first business subscriber, a first streaming radio broadcast comprising the customized first playlist, and transmit, through the network, to at least one business location of the second business subscriber, a second streaming radio broadcast comprising the customized second playlist.

According to a second aspect of the present disclosure, a device includes an input-output interface and a processor. The network interface is configured for communicatively coupling the device to a network and receiving therefrom, a customized streaming radio broadcast comprising a customized playlist that includes at least one radio commercial and one or more songs, the customized playlist explicitly tailored for a first business subscriber. The processor is configured to process and convert the customized streaming radio broadcast into an audio signal that is reproducible through a speaker system located in at least one business location of the first business subscriber.

According to a third aspect of the present disclosure, a system includes a first plurality of receiving devices located at a first business establishment location, each of the first plurality of receiving devices configured to receive a first streaming customized radio broadcast by using a first Uniform Resource Locator (URL) that uniquely identifies a first server configured to provide the first streaming customized radio broadcast to each of the first plurality of receiving devices, the first streaming customized radio broadcast comprising a first plurality of radio commercials explicitly targeting the first business establishment location on the basis of a differentiation between the first business establishment location and a second business establishment location.

The details of one or more embodiments of the disclosure are set forth in the accompanying drawings and the description below. Other features, objects, and advantages will be apparent from the description, drawings, and from the claims.

### BRIEF DESCRIPTION OF THE DRAWINGS

The accompanying drawings, which are incorporated into and constitute a part of this specification, illustrate one or more embodiments of the present disclosure and, together with the detailed description, serve to explain various aspects, principles and implementations of the disclosure.

FIG. 1 illustrates a high-level block diagram of an exemplary system infrastructure and possible various components;

FIG. 2 illustrates exemplary functions of a central server, including how a Central Server Task Manager determines proper actions to perform and delegate in response to requests from production facilities and MPAs;

FIG. 3 depicts exemplary processes executed by a central server receiving and parsing channel playlists and playlist overrides;

FIG. 4 illustrates an exemplary production facility, broken into components such as program director, program accountant, and media manager;

FIG. 5 illustrates the a manner in which the streaming synthesizer mixes resources together;

FIG. 6 illustrates a manner in which the MPA's playback synthesizer mixes the channel audio stream with resources;

FIG. 7 illustrates the manner in which the streaming synthesizer mixes resources together to create a component;

FIG. 8 illustrates a more detailed view of an exemplary MPA, as an example, broken into its three primary components: the playback synthesizer, a streaming mechanism, and an MPA Task Manager;

FIG. 9 shows a functional view to describe the operation of a streaming synthesizer;

FIG. 10 shows a functional view to describe the operation of a playback synthesizer;

FIG. 11A-B shows a functional view to describe the operation of a program director;

FIG. 12 A-B shows a functional view to describe the operation of a program accountant;

FIG. 13 shows a functional view to describe the operation of a media manager;

FIG. 14 shows a few basic elements of computer system that may be used to implement various functional elements described herein.

### DETAILED DESCRIPTION

Provided herein are systems and methods to streamline the production of, and execute the delivery of, uniquely designed and constructed audio streams that are produced, tailored, and targeted at specific demographics, that support the branding, atmospheric, energetic, and promotional needs of business establishments, and that broadcast over speakers in business establishment locations.

The following is a set of terms utilized in the present disclosure, indicating their meanings as utilized herein.

| | |
|---|---|
| MPA | a touch-screen Media Player Appliance placed at each subscriber |
| | location for audio playback and end user interaction |
| Subscriber | a grouping of one or more business establishment locations that |
| | subscribe to the broadcasting service as a unit and receive |
| | identical audio stream content (relative to one another when the |
| | subscriber comprises more than one business establishment |
| | location) |
| Production Facility | a set of networked applications, installed on computers that reside |
| | at one or more sanctioned remote locations, that facilitate |
| | production and managerial activities and interface with a central |
| | server |
| Central Server | a server to which all production facilities and MPAs connect to |
| | and interface with |
| Streaming | a software application that utilizes a client-to-server transfer |
| Mechanism | protocol for converting static digital audio data into a plurality of |
| | dynamic streams of digital audio bits that are accessible at defined |
| | URLs (Uniform Resource Locator). The accessed digital audio |
| | bits can then be suitably processed for audio reproduction through |
| | audio output devices, such as speakers and headphones. In |
| | addition to, or alternatively, the Streaming Mechanism may utilize |
| | a peer-to-peer transfer protocol in order to maximize network |
| | resources and bandwidth efficiency. |
| Channel | a specific genre of radio program, available for subscribers to |
| | choose from (for example, Classic Rock, Country, Alternative, |
| | Techno, etc . . .) |
| Resource | a media file residing on a data storage mechanism. |
| Element | a general class that describes the quality of a group of resources |
| ResourceRef | a reference to a resource in a playlist |
| ElementRef | a reference to an Element in a Playlist |
| Playlist | a delineated sequence of ElementRefs and/or ResourceRefs along |
| | with other specific instructions |
| Channel Element | an Element that classifies a family of Channel Resources |
| Channel Resource | an audio file that is a member of a Channel Element |
| Subscriber | an audio file that is a member of a Subscriber Element |
| Resource | |
| Subscriber Element | an Element that classifies a family of Subscriber Resources |
| Playlist Parser | a Central Server software device that evaluates Playlists and |
| | processes them in various ways |
| TOD | an instruction in a Playlist read by the Playlist Parser that denotes |
| | the particular time of day to begin streaming that particular |
| | Playlist |
| Playtime | a specific day and time, defined within a Playlist, instructing the |
| | MPA's Playback Synthesizer to play the associated Resource or |
| | audio stream of the Playlist at that specific day and time |
| Channel Playlist | a class of Playlist that is generated by a Production Facility and |
| | serves as a template for Subscriber Playlists that are assigned to |
| | the Channel |
| Subscriber Playlist | a class of Playlist generated by the Central Server that inherits |
| | some ElementRefs and/or ResourceRefs from a Channel Playlist |
| | and substitutes Subscriber-specific ElementRefs and/or |
| | ResourceRefs for others |
| Playlist Command | a command within a Playlist instructing the Streaming and |
| | Playlist Synthesizers to perform various digital audio processing |
| | on Resources. Such digital audio processing can include, but is |
| | not limited to, overlapping one Resource with another Resource |
| | by a specific number of seconds, adjusting the gain of a whole or |
| | part of a Resource, applying a graduated increase or decrease of |
| | gain on a Resource over a length of time, combining two or more |
| | Resources into a Component or any combination thereof |
| Playlist Override | a Playlist that inherits some Elements and/or Resources from a |
| | parent Channel Playlist or Subscriber Playlist and replaces some |
| | Elements and/or Resources with other Elements and/or Resources |
| Channel Audio | a stream of audio content instantiated by the Streaming |
| Stream | Synthesizer that is pulled down by each MPA and mixed with |
| | Resources that reside on each MPA |
| Component | A composite Resource created by the Streaming Synthesizer as a |
| | result of a series of Playlist Commands |
| Streaming | a Central Server computer program in accordance with the |
| Synthesizer | disclosure that takes instructions from the Central Server Task |
| | Manager, mixes Resources according to a set of Playlist |
| | Commands, and outputs the result to the Central Server Streaming |
| | Mechanism |
| Playback | an MPA computer program in accordance with the disclosure that |
| Synthesizer | takes instructions from the MPA Task Manager, mixes Resources |
| | with Channel Audio Streams according to a set of Playlist |
| | Commands, and outputs the result to the MPA Streaming |
| | Mechanism |
| Daypart | a section of a specific day during which specific Elements are |
| | scheduled to occur (played back through a speaker, for example) |
| Advertiser | an entity that purchases airtime on a Subscriber's radio |
| | show/broadcast |
| Sponsor | a third party that pays a fee to be mentioned as a sponsor of a |
| | Subscriber's radio show/broadcast |
| Promotional | a Subscriber Resource that is designed to promote a good or |
| Announcement | service provided by that specific Subscriber |
| (“Promo”) | |
| Commercial | a Subscriber Resource that is designed to promote a good or |
| | service provided by an Advertiser. |
| Program Director | a Production Facility computer program in accordance with the |
| | disclosure that performs functions related to the scheduling and |
| | recordkeeping of Playlists, maintenance of Resources and audio |
| | streams, etc. |
| Program | a Production Facility computer program in accordance with the |
| Accountant | disclosure that performs functions related to the recordkeeping of |
| | Subscribers, Advertisers, MPAs, and the like |
| Media Manager | a Production Facility computer program in accordance with the |
| | disclosure that performs functions related to the processing of |
| | Resources and communication between Production Facilities and |
| | the Central Server |
| Radio show host | referred to herein by a variety of terms such as radio personality, |
| | disk jockey (DJ), radio disk jockey, etc. |

Having now defined particular terms utilized in the instant disclosure, various aspects and elements for systems and associated methods of designing and producing custom audio content for groups of business establishments from a plurality of production locations, organizing that audio content at a central location into live audio streams, and delivering those streams to the corresponding business establishment locations for broadcast and audible playback is disclosed.

The present disclosure provides custom, commercial radio-style programmed audio streams that consist of live, up-to-the-minute, compelling radio personality (DJ) interludes interspersed with various other classes of audio Elements, e.g. and not limited to songs, sweepers, jingles, phone interviews and testimonials, celebrity endorsements, Commercials, Promos, news and sports updates, station ids, and other Subscriber Elements and that are broadcast over speakers in business establishments. Accordingly, such customized audio streams can be provided for the purpose of entertaining and informing customers and employees, influencing customer purchasing decisions, enforcing brand, creating a positive and enthusiastic atmosphere, building customers' confidence in the business establishment, building employee team cohesion and pride, motivating employees, generating revenue from Advertisers and Sponsors, and generating a “buzz” that compels customers to listen and take in the messages that the Advertisers and Sponsors are communicating at a particular (one) or plurality of business establishment locations.

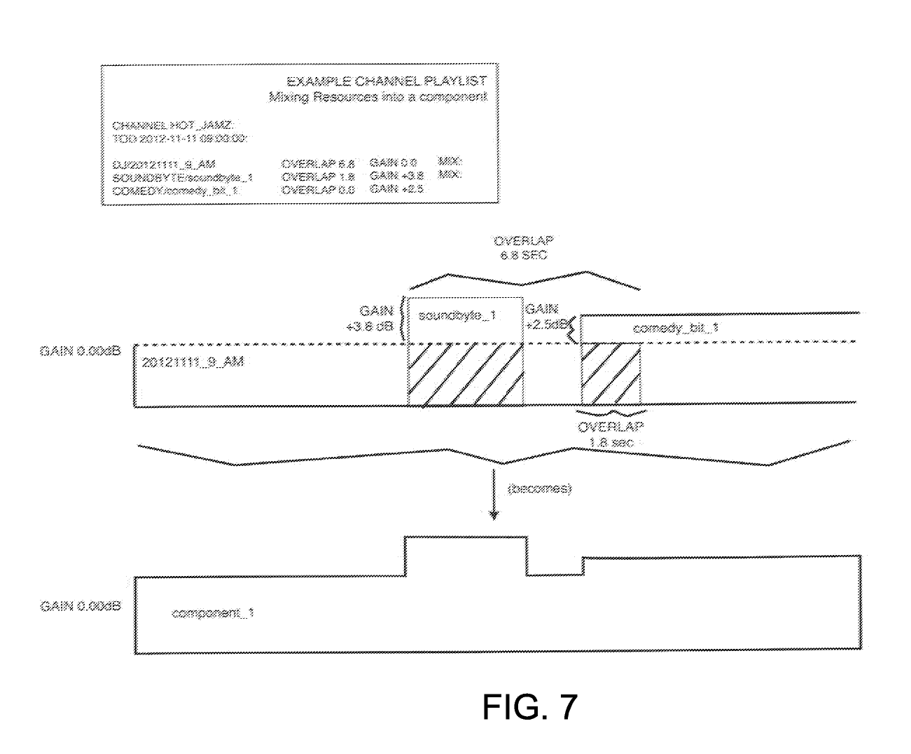

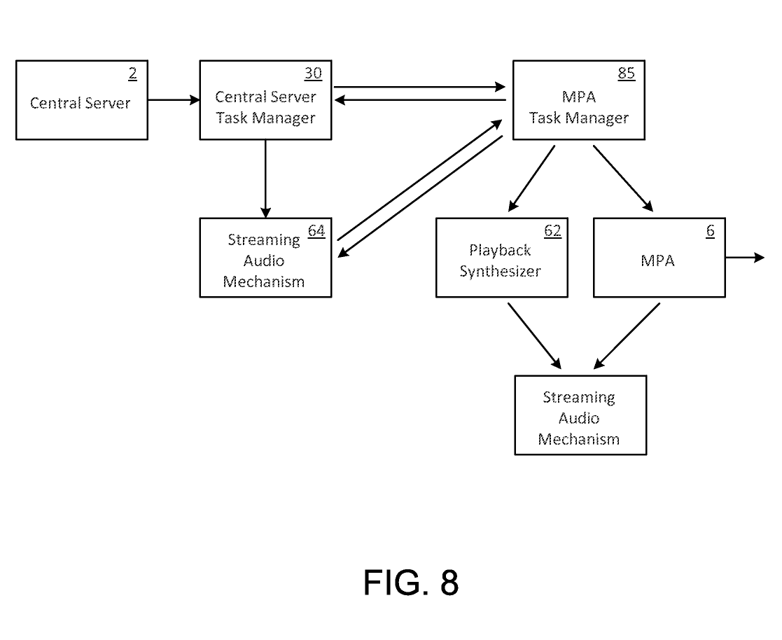

These custom audio streams provided in accordance with the instant disclosure achieve an aesthetic quality virtually indistinguishable from commercial broadcast FM radio, utilizing techniques such as, for example, DJ introductions to songs that “talk up the ramp,” i.e., overlap with the intro of the song until the point at which the vocal track starts, such that and in an example, the volume level of the song intro does not overpower the DJ track. Other techniques include, for example, overlapping the tail of one Element, e.g., a commercial, with the head of the following Element, e.g., a sweeper, so as to prevent any instances of “dead air,” i.e., silence, as well as adjusting the playback volume level of each Element in order to maintain a steady overall volume level between all Elements, or in other cases, to deliberately make one Element louder than another. One example, which is described below using FIG. 7, pertains to Elements such as a DJ announcement, a sound bite, and/or a comedic interlude.

In accordance with the instant disclosure, the production and distribution of all audio Resources required by each custom audio stream is streamlined through the infrastructure and automation techniques provided herein. In one example, the infrastructure is comprised of a plurality of Production Facilities securely connecting to a Central Server, and a plurality of Media Player Appliances (MPAs) residing at business establishment locations and securely connecting to a Central Server.

In accordance with one aspect and example, functions of Production Facilities can include, but are not limited to, organizing and maintaining database information on the Central Server, generating and processing audio Resources, synching Resources with the Central Server, generating Channel Playlists and Playlist Overrides, and providing instructions to the Central Server about how to process those Playlists.

In another aspect and example, functions of the Central Server can include serving a master file system, organizing all Resources in the master file system, serving the master database, and storing information relating to: Resources, file names, metadata, playback durations, Element type classification, etc., Subscribers and their MPAs, available Channels and their assignments to Subscribers, Daypart schedules and special Playlist instructions for Subscribers, logs of all successfully played Resources by each MPA, and any special fees associated with those Resources. A few examples of special fees include special fees paid by advertisers and/or sponsors. A log entry may be made to keep track of each of the items that are streamed successfully, and billed accordingly. The Central Server can serve other/additional functions which can include, but are not limited to, parsing Channel Playlists as they are added to the queue by various Production Facilities, generating a plurality of custom Subscriber Playlists based on those Channel Playlists, instantiating audio streams based on Channel Playlists, assigning Subscriber Playlists to specific MPAs, and serving Subscriber Playlists and Resources to MPAs.

In accordance with the present disclosure, the functions of MPAs can include, but are not limited to, maintaining a constant secure connection to the Central Server, retrieving assigned Subscriber Playlists and Subscriber Resources from the Central Server, connecting to the assigned Channel audio stream, inserting Subscriber Resources into the Channel audio stream according to each Playlist-defined Playtime and associated mixing Commands, pushing the resulting composite audio stream to speakers on a business establishment's premises, and notifying the Central Server of successful playback of various Resources.

In yet another aspect, the present disclosure provides a web site where Subscribers and Advertisers can log in and view their accounts. While logged in, Subscribers can, for example, request changes to their Subscriber Playlists, request the production of new Subscriber Resources, and upload Resources for processing by a Production Facility. Advertisers can purchase air time on specific days and Dayparts for their Commercials to play in specific Subscriber's business establishment(s), as well as upload Resources for processing by a Production Facility. This procedure may be carried out for example, by a subscriber and/or advertiser logging into a website and clicking on an icon labeled “Upload file” which brings up a finder window. The subscriber/advertiser can then select a file located on a hard drive and click “OK,” upon which the file is uploaded to a specific area of the central file server designated for that Subscriber/Advertiser.

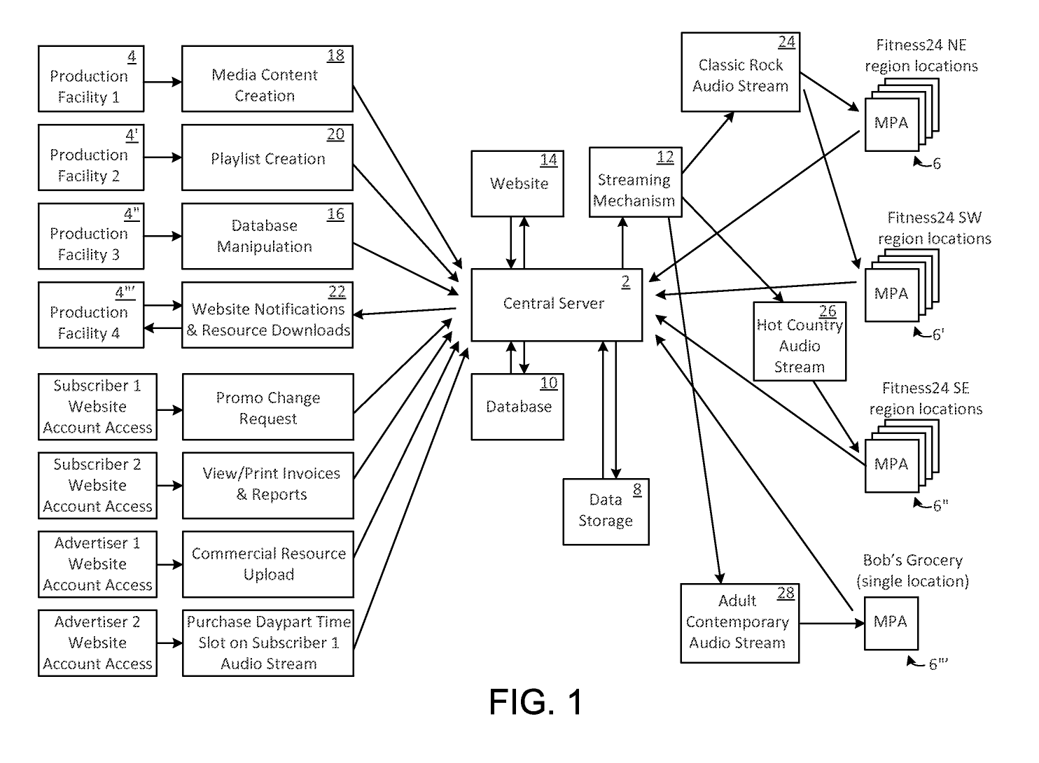

Now turning to FIG. 1 and in accordance with a particular embodiment, a high-level block diagram is provided which illustrates an example of a system infrastructure and various components that it can be comprised of. The primary components are a Central Server 2, one or more Production Facilities 4, 4′, 4″ and 4′″ and an MPA(s) (Media Player Appliance(s)) 6, 6′, 6″ and 6′″. When utilizing reference numerals with “prime” or “double prime” designations herein, it is to be understood that such designations are particular to the specific figure in which they are depicted, whereas a base reference numeral (i.e. without any “prime” designation) will refer to a particular element/aspect in general (e.g. in FIG. 1, reference numeral 6 refers to MPAs in a general sense, whereas 6′ is utilized to distinguish the MPAs at a distinct demographic/region from MPAs at other regions).

In this depiction, a single Central Server 2 (with backup locations for redundancy and failover purposes, not shown) serves as the communications and data storage/retrieval center for all Production Facilities (4-4′″) and MPAs (6-6′″). The primary components of the Central Server 2 include a data storage mechanism 8, a SQL database 10, a Central Server Task Manager 30, a Playlist Parser, a Streaming Synthesizer, a Streaming Mechanism 12, and a Website 12.

FIG. 1 shows a plurality of Production Facilities (4-4′″), which function to communicate securely with the Central Server 2, organize and maintain database information (Database Manipulation 16) on the Central Server 2, generate audio Resources (Media Content Creation 18), exchange Resources with the Central Server (Website Notifications & Resource Downloads 22), and generate Channel Playlists and Playlist Overrides (Playlist Creation 20).

As shown in one example, FIG. 1 depicts a plurality of MPAs (Media Player Appliances) 6, 6′, 6″, 6′″ grouped together in various ways. An example of a possible Subscriber Playlist is shown in Table 1 below, where, in the first line, a Subscriber Name is given (here shown as “STREAM Fitness24Northeast”), and in the second line the TOD is specified (here shown as “TOD 2012-11-11 09:00:00”. Below the TOD is shown the playtime at the leftmost portion of Table 1, which as indicated herein, runs from 09:00:00 to 09:51:53. It may be pertinent to point out that the time label “09:51:53” is indicative of a start time of the last item “Classic_Rock_Stream” to play during the 9 O'Clock hour. This Element will play for another 8:07 to finish out the full 60 minutes. To the immediate right of the playtimes are either a Channel Audio Stream (depicted here as “Classic_Rock_Stream”, for example) or a Subscriber ResourceRef (particular ones/types depicted here, for example, as “Fitness24Northeast_phoner_{—}1”, “Fitness24Northeast_sweeper_{—}6”, “Fitness24Northeast_promo_{—}1”, “ProteinPower_commercial”, “Fitness24Northeast_jingle_{—}3”, “Fitness24Northeast_sweeper_{—}2”). The two right-most columns of Table 1 make up the Playlist Command, where OVERLAP and GAIN are specified (examples are shown in Table 1 below).

TABLE 1
Example Subscriber Playlist

STREAM Fitness24Northeast;
TOD 2012-11-11 09:00:00;

| | | | |
|---|---|---|---|
| 09:00:00 | Classic_Rock_Stream | OVERLAP 1.8 | GAIN 0.0 |
| 09:08:32 | Fitness24Northeast_phoner_1 | OVERLAP 0.8 | GAIN 0.0 |
| 09:09:02 | Classic_Rock_Stream | OVERLAP 3.3 | GAIN 0.0 |
| 09:13:48 | Fitness24Northeast_sweeper_6 | OVERLAP 0.4 | GAIN 0.0 |
| 09:13:55 | Classic_Rock_Stream | OVERLAP 2.5 | GAIN 0.0 |
| 09:28:43 | Fitness24Northeast_promo_1 | OVERLAP 1.1 | GAIN +2.5 |
| 09:29:13 | Classic_Rock_Stream | OVERLAP 6.1 | GAIN 0.0 |
| 09:34:13 | ProteinPower_commercial | OVERLAP 0.5 | GAIN +2.5 |
| 09:34:43 | Classic_Rock_Stream | OVERLAP 1.9 | GAIN 0.0 |
| 09:40:04 | Fitness24Northeast_jingle_3 | OVERLAP 0.8 | GAIN 0.0 |
| 09:40:17 | Classic_Rock_Stream | OVERLAP 4.6 | GAIN 0.0 |
| 09:51:46 | Fitness24Northeast_sweeper_2 | OVERLAP 0.6 | GAIN 0.0 |
| 09:51:53 | Classic_Rock_Stream | OVERLAP 0.5 | GAIN 0.0 |

In correspondence with Table 1 above and FIG. 1, it is shown, as an example, that the Fitness24 corporation has divided their franchises into three national regions: Northeast, Southwest, and Southeast regions. Given some commonality between the demographics of the Northeast and Southwest regions, the “Classic Rock” Channel (Classic Rock Audio Stream 24, in FIG. 1) is streamed to all locations in both regions. More detailed targeting of demographics is nonetheless desired, and so achieved: the Southwest region is assigned a different Subscriber Playlist and corresponding set of Subscriber Resources than that of the Northeast region, resulting in two “Classic Rock” radio programs customized for the demographics of each national region. In an effort to satisfy a demographic with no commonality to the other two regions, a “Hot Country” Channel (Hot Country Audio Stream 26, in FIG. 1) is established and streamed to the Southeast region locations, along with a unique Subscriber Playlist tailored for that demographic. To further elucidate the degree of customization possible with the system infrastructure, FIG. 1 further shows an unrelated, single location Subscriber, named “Bob's Grocery,” connected to a completely different “Adult Contemporary” Channel (Adult Contemporary Audio Stream 28, in FIG. 1) and receiving its own unique Subscriber Playlist.

Still referring to FIG. 1 and the exemplary Subscriber Playlist of Table 1, an example of a Subscriber Playlist is generated by the Playlist Parser for a Subscriber named “Fitness24,” who is assigned to the “Classic Rock” Channel, and whose entire fleet of stores in the Northeast region of the country will access the “Classic Rock” Channel audio stream by way of the MPAs residing in each of their stores. Note that all ElementRefs have been converted into one of two possibilities: a Channel Audio Stream and a ResourceRef. An MPA assigned to the Fitness24 Northeast region will retrieve this Subscriber Playlist from the Central Server along with all of the listed Resources, queue up the Playlist for playback at the TOD, and use the Playback Synthesizer to play back each Playlist item at each defined Playtime, observing all Playlist Commands in the same manner that the Streaming Synthesizer would.

Table 2 (below) shows an example of a Channel Playlist. In this example, the playlist is a “Classic Rock” Channel Playlist. The various components defined are similar to those in Table 1. The first line in the Channel Playlist of Table 2 shows the Channel Name (here “Classic_Rock”), and directly underneath is the TOD. In this example, Channel ResourceRef are shown here, as an example, as “NEWS/9_AM”, “SONGS/song_{—}1”, “SONGS/song_{—}2”, “SONGS/song_{—}3”, “SONGS/song_{—}4”, “SONGS/song_{—}5”, “SONGS/song_{—}6”, “SONGS/song_{—}7”, “SONGS/song_{—}8”, “DJ/20121111_{—}9_AM”.

Referring to Table 2, Subscriber ElementRefs (explicit) are shown here, as an example, as “PHONER/phoner_{—}1”, “SWEEPER/sweeper_{—}6;”, “PROMO/promo_{—}1;”, “JINGLE/jingle_{—}3;”, and “SWEEPER/sweeper_{—}2;”). Subscriber ElementRef (implicit) is also shown here, as an example as “COMMERCIAL/getCommercial( )”. As in Table 1, Table 2 shows Playlist Commands “OVERLAP” and “GAIN”. In addition, in the example Channel Playlist of Table 2, there is provided and shown here Voicetrack Playlist Command, as an example as “VTGAIN” and “VTRAMP”, as discussed later in the disclosure.

A Channel Playlist results in a Channel Audio Stream of the same name instantiated by the Streaming Synthesizer in the Streaming Mechanism. A note of detail regarding the Playlist shown in Table 2: an explicit ElementRef instructs the Playlist Parser to choose a particular ResourceRef in place of the given ElementRef, while an implicit ElementRef instructs the Playlist Parser to choose a ResourceRef by way of a separate sub-process. In this case, the sub-process accesses the database for the latest Commercial scheduled to play during the current Daypart for the given Subscriber.

TABLE 2
Example Channel Playlist

| | | | |
|---|---|---|---|
| CHANNEL Classic_Rock; | | | |
| TOD 2012-11-11 09:00:00; | | | |
| NEWS/9_AM | OVERLAP 1.0 | GAIN 0.0; | |
| SONGS/song_1 | OVERLAP 1.8 | GAIN 0.0; | |
| PHONER/phoner_1; | | | |
| SONGS/song_2 | OVERLAP 3.3 | GAIN 0.0; | |
| SWEEPER/sweeper_6; | | | |
| SONGS/song_3 | OVERLAP 7.8 | GAIN 0.0; | |
| DJ/20121111_9_AM | OVERLAP 5.0 | GAIN 0.0 | VTGAIN −9.0 VTRAMP 2.5; |
| SONGS/song_4 | OVERLAP 2.5 | GAIN 0.0; | |
| PROMO/promo_1; | | | |
| SONGS/song_5 | OVERLAP 6.1 | GAIN 0.0; | |

COMMERCIAL/getCommercial( );

| | | |
|---|---|---|
| SONGS/song_6 | OVERLAP 1.9 | GAIN 0.0; |
| JINGLE/jingle_3; | | |
| SONGS/song_7 | OVERLAP 4.6 | GAIN 0.0; |
| SWEEPER/sweeper_2; | | |
| SONGS/song_8 | OVERLAP 0.5 | GAIN 0.0; |

Table 3, below, denotes a Channel Playlist Override. In one example embodiment, a Playlist Override is generated by a Subscriber via a website account and passed on to a Program Director, who then executes changes to a Subscriber Playlist via a Playlist Override. Note the substitution of two Promos in place of News in the parent Channel Playlist (Table 2). In this example the Override Stream Playlist Command is shown here, and as an example, as “OVERRIDE STREAM Fitness24Southwest;”, whereas the Subscriber ElementRef Override (explicit) in this example is shown here as “PROMO/promo_{—}9;” and “PROMO/promo_{—}5;”.

TABLE 3
Example Channel Playlist Override

CHANNEL Classic_Rock;
OVERRIDE STREAM Fitness24Southwest;
TOD 2012-11-11 09:00:00;

| | | | |
|---|---|---|---|
| PROMO/promo_9; | | | |
| PROMO/promo_5; | | | |
| SONGS/song_1 | OVERLAP 1.8 | GAIN 0.0; | |
| PHONER/phoner_1; | | | |
| SONGS/song_2 | OVERLAP 3.3 | GAIN 0.0; | |
| SWEEPER/sweeper_6; | | | |
| SONGS/song_3 | OVERLAP 7.8 | GAIN 0.0; | |
| DJ/20121111_9_AM | OVERLAP 5.0 | GAIN 0.0 | VTGAIN −9.0 VTRAMP 2.5; |
| SONGS/song_4 | OVERLAP 2.5 | GAIN 0.0; | |
| PROMO/promo_1; | | | |
| SONGS/song_5 | OVERLAP 6.1 | GAIN 0.0; | |

COMMERCIAL/getCommercial( );

| | | |
|---|---|---|
| SONGS/song_6 | OVERLAP 1.9 | GAIN 0.0; |
| JINGLE/jingle_3; | | |
| SONGS/song_7 | OVERLAP 4.6 | GAIN 0.0; |
| SWEEPER/sweeper_2; | | |
| SONGS/song_8 | OVERLAP 0.5 | GAIN 0.0; |

Table 4, below, shows an example of an overridden Subscriber Playlist, which was generated in exactly the same manner as the “Fitness24Northeast” Playlist from Table 1, except for the fact that it inherited from the Channel Playlist Override (as shown in the example of Table 3). As an example, this overridden Subscriber Playlist is retrieved by all of the MPAs belonging to the Fitness24 Southwest region stores. As a result, all of the Southwest region stores hear the two Promos play at the top of the hour, while all of the Northeast region stores hear the news play at the top of the hour.

TABLE 4
Example Overridden Subscriber Playlist

STREAM Fitness24Southwest;
TOD 2012-11-11 09:00:00;

| | | |
|---|---|---|
| 09:00:00 Fitness24Southwest_promo9 | OVERLAP 1.2 | GAIN +2.5; |
| 09:01:00 Fitness24Southwest_promo5 | OVERLAP 0.9 | GAIN +2.5; |
| 09:02:00 Classic_Rock_Stream | OVERLAP 1.8 | GAIN 0.0; |
| 09:08:32 Fitness24Southwest_phoner_1 | OVERLAP 0.8 | GAIN 0.0; |
| 09:09:02Classic_Rock_Stream | OVERLAP 3.3 | GAIN 0.0; |
| 09:13:48 Fitness24Southwest_sweeper_6 | OVERLAP 0.4 | GAIN 0.0; |
| 09:13:55 Classic_Rock_Stream | OVERLAP 2.5 | GAIN 0.0; |
| 09:28:43 Fitness24Southwest_promo_1 | OVERLAP 1.1 | GAIN +2.5; |
| 09:29:13 Classic_Rock_Stream | OVERLAP 6.1 | GAIN 0.0; |
| 09:34:13 ProteinPower_commercial | OVERLAP 0.5 | GAIN +2.5; |
| 09:34:43 Classic_Rock_Stream | OVERLAP 1.9 | GAIN 0.0; |
| 09:40:04 Fitness24Southwest_jingle_3 | OVERLAP 0.8 | GAIN 0.0; |
| 09:40:17 Classic_Rock_Stream | OVERLAP 4.6 | GAIN 0.0; |
| 09:51:46 Fitness24Southwest_sweeper_2 | OVERLAP 0.6 | GAIN 0.0; |
| 09:51:53 Classic_Rock_Stream | OVERLAP 0.5 | GAIN 0.0; |

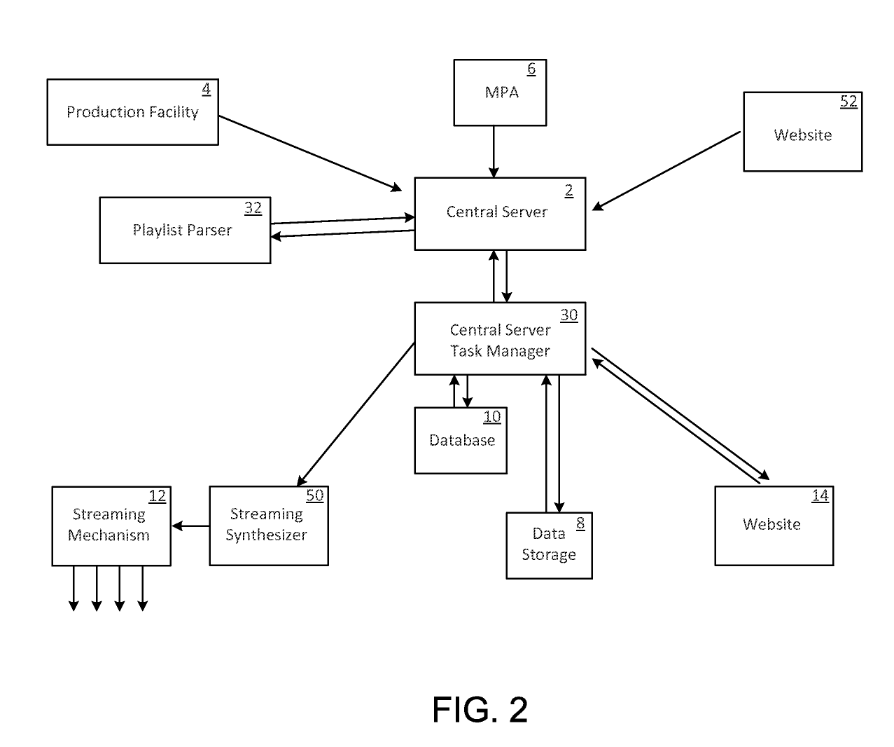

Turning now to FIG. 2, exemplary functions of a Central Server 2 are depicted, including how the Central Server Task Manager 30 determines proper actions to perform and delegate in response to requests from Production Facilities 4 and MPAs 6.

Exemplary functions include, but are not limited to any one or combination of, parsing by the Playlist Parser 32 of all Channel Playlists and Playlist Overrides for each hour of each day resulting in the propagation of a plurality of Subscriber Playlists whereby i) Subscriber Playlists inherit from Channel Playlists, ii) each Channel Playlist propagates into one Subscriber Playlist for each Subscriber that is assigned to the given Channel, iii) Subscriber ElementRefs are converted into Subscriber ResourceRefs, iv) Channel ElementRefs are converted into Channel ResourceRefs, v) each Playlist Override generates a Subscriber Playlist in which specific ResourceRefs and ElementRefs from the inherited Channel Playlist are added or removed and vi) Subscriber Playlists are assigned to specific MPAs.

Further functions of the Central Server 2 can include mixing Resources according to each Channel Playlist Command, and outputting the results as Channel Audio Streams and/or Components, as well as comparing and contrasting a population of Channel and Subscriber Playlists for the purpose of identifying i) shared Resources vs. single-purpose Resources, ii) Components to be generated, iii) shared Components vs. single-purpose Components and Resources and Components that are proximate in Playlist TOD and/or data storage location.

Additional functions can include identifying constraints to guide audio stream production activities, including, for example, i) Resources and Components that need be available by a specific date and time, ii) queueing of Resources and Components with priority given to time of first playback and iii) queueing of Resources and Components with priority given to Element type. Further functions include instantiating Channel audio streams by way of the Streaming Mechanism while observing for example, Subscriber bandwidth requirements, shared Resources and Components and priority queues.

Central Server 2 can also provide managerial functions, such as managing the data storage mechanism by, for example: i) organizing Resources and files by means of a partition function that assigns each available resource to one or more groupings, or shards, based on anticipated access patterns, failure modes, or other criteria, and a synchronization process that presents a unified view of the contents of all available shards, which may exist on disparate storage devices and host systems; and/or ii) delivering Subscriber Resources to MPAs, iii) delivering Channel Resources and Components to the Streaming Synthesizer 50, and iv) receiving Resources from Production Facility 4 and web site user(s) 52. Further functions of the Central Server 2 can include serving the master database to i) all instances of Program Accountant 54 and Program Director, ii) all MPAs, iii) Subscribers' and Advertisers' website accounts, and iv) Media Manager 48.

Database 10 stores information relating to, but not limited to, i) all Program Director and Program Accountant users' information, such as, for example, login credentials, login status, history of logins, login location, contact information, full name, and authorization level; ii) Subscriber information, such as, for example, business name, address, contact person, phone number, fax, and email; iii) Advertiser information, such as, for example, company name, address, contact person, phone number, fax, and email; iv) MPA related information, such as, for example: model number, unique ID, physical location, authorized status, URL for stream connection and Central Server communication; vi) Subscribers' preference of Channels to be made available to each of their locations, and vii) Subscribers' bandwidth requirements.

The website 14 provides a central location where Subscribers log in to secure accounts and can, alone or in any combination, for example, request changes to Promos, upload Promos and upload Commercials for Advertisers and Sponsors. The website 14 additionally provides a central location where Advertisers and Sponsors log in to secure accounts where they can, alone or in any combination, purchase Daypart slots for their own Commercials on specific Subscriber's audio streams and upload Commercials to the Central Server 2.

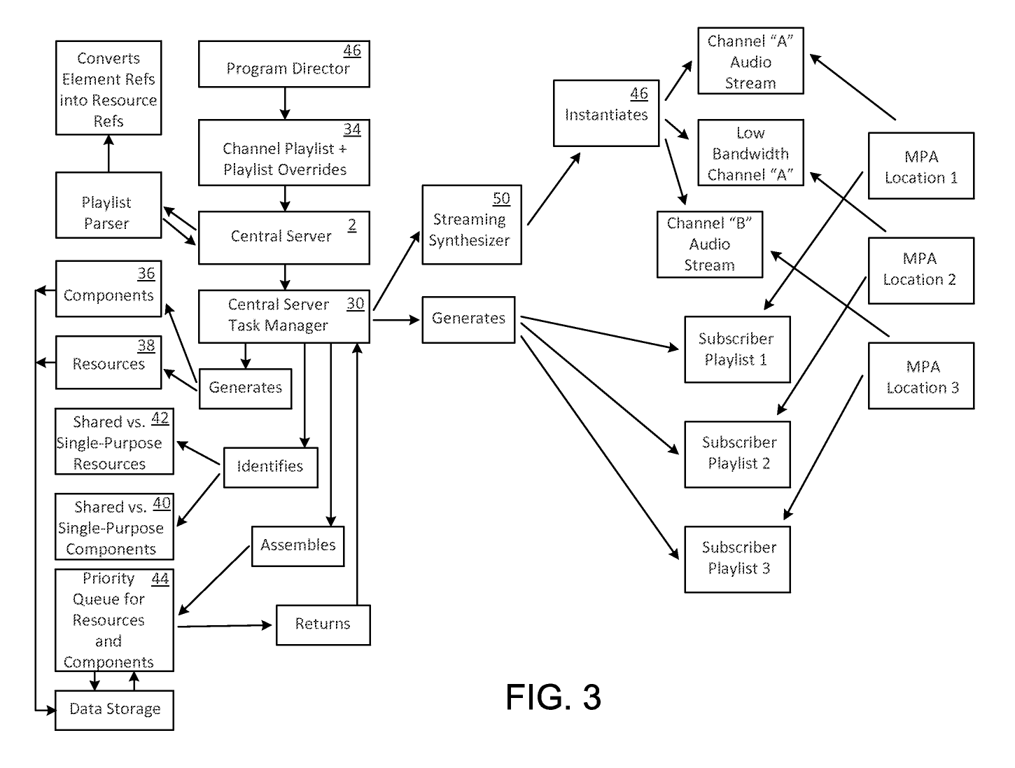

FIG. 3 illustrates the process by which the Central Server receives and parses Channel Playlists and Playlist Overrides 34, converts them into Components 36 and Resources 38, identifies shared vs. single-purpose Components 40 and Resources 42, establishes a priority queue for Resources and Components 44, instantiates audio streams 46, and delivers Subscriber Playlists to their assigned MPAs.

Further functions of Central Server 2 can include notifying all instances of Program Accountant 54 and Program Director of changes to Resources. Additional functions of Central Server 2 can include maintaining logs of, for example i) all Program Accountant 54 and Program Director logins and actions performed, ii) Resources that were successfully broadcast by each individual MPA 6 and errors thrown by Program Director 46, Program Accountant 54, MPAs, Media Manager 48, and Central Server 2 processes.

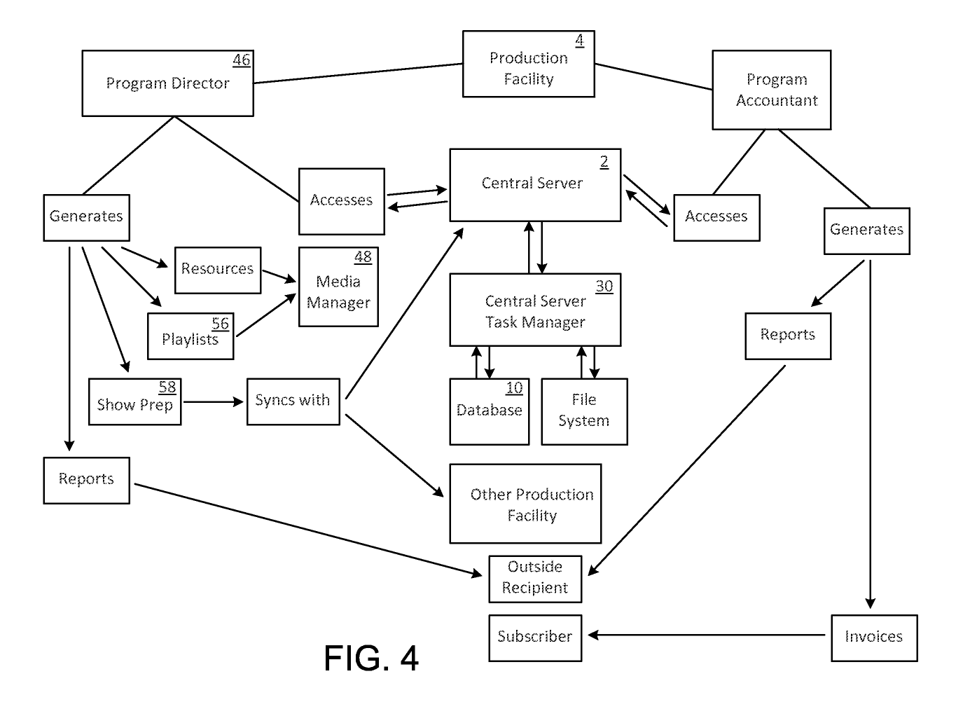

Now referring to FIG. 4, a more detailed view of a Production Facility 4 that includes three primary components: Program Director 46, Program Accountant 54, and Media Manager 48.

Program Director 46 can perform various functions including, but not limited to, first, maintaining various Central Server database information including, but not limited to Channel Resources, Subscriber Resources, Channel Elements, Subscriber Elements, Channels, Subscribers, Subscriber assignments to Channels, Gain adjustments on Elements for each Subscriber, bandwidth throttle values for each Subscriber, scheduling and play history of all Resources and Elements; second, designing and generating Channel Playlists consisting of various items including, but not limited to, the name of the Channel that the Playlist will be instantiated as, TOD, Channel ElementRefs and ResourceRefs (referring to, but not limited to, songs, DJ Announcements, comedy bits, parody songs, soundbites, news and sports, for example), Subscriber ElementRefs and ResourceRefs (referring to, but not limited to, Promos, Commercials, phone interviews/testimonials, celebrity endorsements, sweepers, liners, jingles, station IDs, for example), Playlist Commands (including, but not limited to):

1. OVERLAP [sec], which instructs the Streaming Synthesizer/Playback Synthesizer to overlap the end of the current Resource with beginning of the next Resource by the amount of seconds given

2. GAIN [dB], which instructs the Streaming Synthesizer/Playback Synthesizer to raise or lower the overall volume of the current Resource by the amount of decibels given

3. VTGAIN [dB], which instructs the Streaming Synthesizer/Playback Synthesizer to lower the volume of the next Resource by the amount of decibels given, but only on the overlapped portion

4. VTRAMP [sec], which instructs the Streaming Synthesizer/Playback Synthesizer to ramp up the volume of the end of the overlapped portion of the next Resource over a period of given seconds

5. MIX, which instructs the Streaming Synthesizer/Playback Synthesizer to perform the Playlist Commands on the given Resources, mixing all of them into a single Component to be stored as a new Resource

6. OVERRIDE STREAM [Subscriber], which instructs the Playlist Parser to generate a unique Subscriber Playlist for the given Subscriber using an altered set of ElementRefs and ResourceRefs.

A third function that Program Director 46 can perform is generating Playlist Overrides that substitute new Subscriber ElementRefs and ResourceRefs in existing Channel Playlists in place of, for example, Channel ResourceRefs and ElementRefs and/or Subscriber ResourceRefs and ElementRefs.

Program Director 46 can perform additional functions including organizing Playlists 56 into hour-long or other time value-calculated blocks with second timing accuracy; designing each Playlist to be unique to each Channel, to support a live radio show atmosphere, and to take into account daily special events, holidays, etc. . . . ; preparing show prep 58 documents for voice talent; preparing reports 60 for music performance reporting requirements (such as paying royalties to various organization such as RIAA, BMI, ASCAP, SESAC and submitting quarterly reports of what songs were played in order to distribute fees to composers, lyricists, and artists appropriately); interfacing with Central Server via Media Manager Application and running simultaneously from a plurality of locations, communicating securely and co-existing seamlessly. More particularly, the Program Director 46 and Program Accountant 54 are designed to be run by multiple users from multiple locations simultaneously. Proper security measures are taken to ensure that only authorized users and locations are able to connect to the Central Server 2 via Program Director 46 and Program Accountant 54. In addition, communication with the Central Server 2 is managed so as to avoid any potential conflicts between actions taken by simultaneous users on the same set of data.

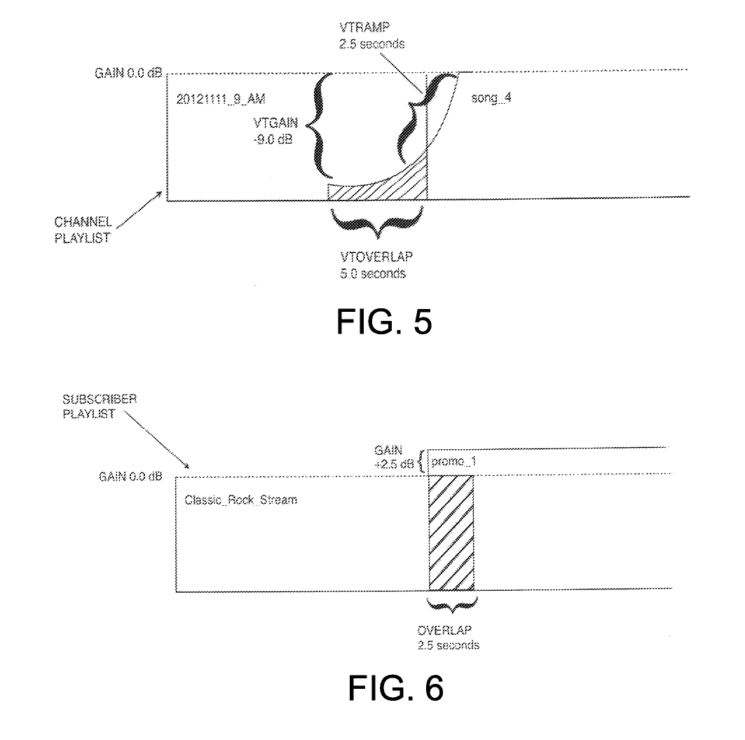

Turning now to FIG. 5, an example of the manner in which the Streaming Synthesizer 50 mixes Resources together is illustrated. In this example (also refer to the example Playlist shown in Table 2), the DJ Resource is mixed with the subsequent song Resource in accordance with the given Playlist Commands. Furthermore and referring to FIG. 6, this example illustrates the manner in which the MPA's Playback Synthesizer mixes the Channel Audio Stream with Resources. In this example, the “Classic Rock” Channel Audio Stream (see Table 2 example Playlist) is mixed with the subsequent Promo Resource in accordance with the given Playlist Commands.

Referring to FIG. 7, an example is provided illustrating the manner in which the Streaming Synthesizer mixes Resources together to create a Component. Note that the Playlist Commands are identical to those found in Channel Playlists and Subscriber Playlists shown in the box of FIG. 7, with the addition of the “MIX” command.

Now turning back to FIG. 4, Program Accountant 54 performs various functions which include, but are not limited to maintaining various Central Server database information including, but not limited to Subscribers' and Advertisers' relevant information, content of all Subscribers' Resources including Promos, Phone Interviews, Commercials for all Subscribers and Advertisers, fees associated with each Commercial for each Daypart for each Advertiser, individual MPA information (including, but not limited to a unique ID or physical location). Some non-limiting examples of MPA information includes: “at manufacturer”, “at warehouse”, “at manufacturer, assigned to subscriber”, “at warehouse, assigned to subscriber”, “in transit from manufacturer to warehouse”, “in transit from manufacturer to subscriber”, “in transit from warehouse to subscriber”, “in transit from subscriber to repair center”, “assigned to sales”, “installed at subscriber location” (the address of the MPA is stored by the MPA's assignment to a subscriber location, which shows the street address). Some additional MPA information may pertain to a physical condition of an MPA, such as, for example, “in inventory, tested OK”, “in inventory, awaiting testing”, “in inventory, tested defective”, “installed at subscriber location and on network”, “installed at client location and off network”, “scheduled for re-test”, and “awaiting return.” Yet other MPA information may include date of manufacture, date of deployment, system software version, touch screen display information, authorized status (whereby an audio stream may be provided/cut-off on the basis of the MPA being authorized for use or not), connection status, power-on greeting, available channels, output sound quality).

Program Accountant 54 can perform additional functions which include, but are not limited to maintaining detailed accounting records of all Subscribers' and Advertisers' financials, maintaining detailed content records of each Subscriber's set of Promos and Commercials, printing invoices for Subscribers and Advertisers on a monthly or other periodic schedule, printing reports on MPAs, Subscribers, and Advertisers, assigning MPAs to individual Subscriber business establishment locations, monitoring each MPA's connection to the Central Server and notifying users when MPAs have newly come on line or dropped a connection, monitoring each MPA's physical location as well as deployment/warehouse/repair status. Program Accountant 54 can further function for communicating with each MPA and controlling various MPA functions including, but not limited to, authorized status (audio stream on/off), power-on audio and/or display greeting, available channels, output sound quality, all touch-screen display information and system software. Additional Program Accountant 54 functions can include monitoring changes to the Central Server database and notifying users of Promo and Commercial change requests, notifying users of newly uploaded Resources as well as running simultaneously from a plurality of locations, communicating securely and co-existing seamles sly.

Still referring to FIG. 4, Media Manager 48 performs various functions including, but not limited to performing tasks on behalf of Program Director, such as exchanging files, Playlists and Resources with the Central Server 2 and other Production Facilities 4, and processing Resources in various ways. Such processing can include, but is not limited to, converting the file format of a given Resource to a different file format (for example, reference-quality, or lossless, formats differing from broadcast-quality, or lossy formats, and files can be converted from one reference-quality format to a different reference-quality format, or from a reference-quality format to a broadcast-quality format, and so on . . . ), applying compression, limiting, EQ, and other digital audio processes to Resources, calculating gain adjustment on audio files in relation to a standard “unity” gain level for all Resources residing in the Central Server data storage mechanism and database, calculating overlap points (an overlap point refers to the precise location at the end of an audio file where the decibels drop to a level where the file can be effectively overlapped with the beginning of the next file in the Playlist. This ensures that the audio stream continues in a seamless fashion and without any “dead air”) for Resources to be employed during stream and Component assembly, and embedding metadata in Resources.

Turning to FIG. 8, a more detailed view of an MPA, broken into its three primary components: the Playback Synthesizer, a Streaming Mechanism, and a MPA Task Manager 85, is illustrated.

The MPA Task Manager 85 performs various functions including, maintaining a constant, secure connection to Central Server, retrieving its assigned Subscriber Playlists from the Central Server, translating Playlist ResourceRefs into Resources, retrieving all Resources needed for playback according to the Playtimes listed in the Playlists and notifying the Central Server of any errors encountered in the process, utilizing a peer-to-peer transfer protocol in order to maximize network resources and bandwidth efficiency, connecting to the Central Server Streaming Mechanism at assigned URLs, queueing each Resource for the Playback Synthesizer at each specified Playlist Playtime (e.g. Tables 1 and 4), retrieving software updates from the Central Server, notifying the Central Server of successful playback of various Resources and/or errors encountered during the playback process, and managing touch screen display/interaction for various purposes.

Managing the touch screen display/interaction can include, for example, displaying Resources' title, artist, album, and other pertinent information, displaying the name of the Subscriber, displaying tech support contact information, displaying current status regarding internet connection, system errors, etc., providing control over audio volume, visually reinforcing branding and other aspects of the streaming audio content.

Turning to the MPA Playback Synthesizer 62 in FIG. 8, MPA Playback Synthesizer 62 performs various functions such as, for example, playing back Channel Audio Streams and Subscriber Resources precisely at each Playlist Playtime and executing each corresponding Playlist Command, in effect mixing them (FIG. 8) into a composite audio stream. MPA Playback Synthesizer 62 can also maintain quality of service “QoS” constraints on the output audio stream by making dynamic substitutions for unexpected, disruptive events while adhering to Playlist Playtime requirements.

The MPA Streaming Mechanism 64 shown in FIG. 8 performs various functions including, but not limited to, pushing the composite audio stream to speakers on the premises of the business establishment and maintaining constant audio output regardless of internet connectivity.

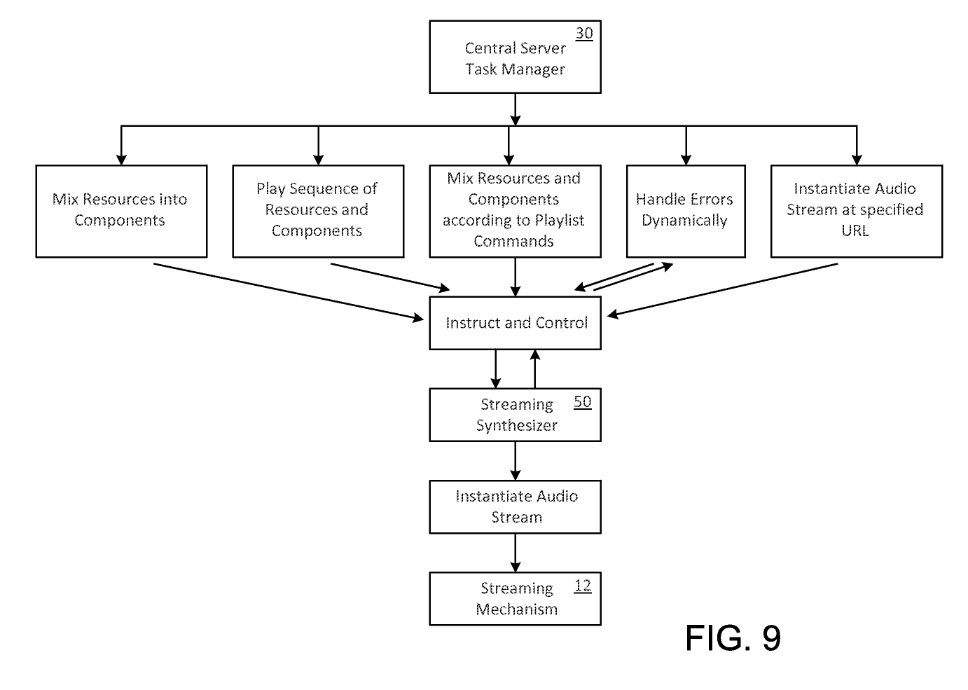

Attention is next drawn to FIG. 9, which shows a Streaming Synthesizer 50 that accepts instructions from, and is controlled by, Central Server Task Manager 30. This configuration provides various dynamic mixing capabilities, such as for example:
Mixing specific Resources together into a Component by a specific date and time
Playing back a sequence of Resources and Components and mixing them together in specific ways, guided by Playlist Commands, resulting in a single stream of audio waveform data
Handling of playback errors in such a way that the resulting audio stream is continuous, seamless, and free of glitches that might be noticeable by listeners
Instantiation of the resulting audio stream in the Streaming Mechanism 12

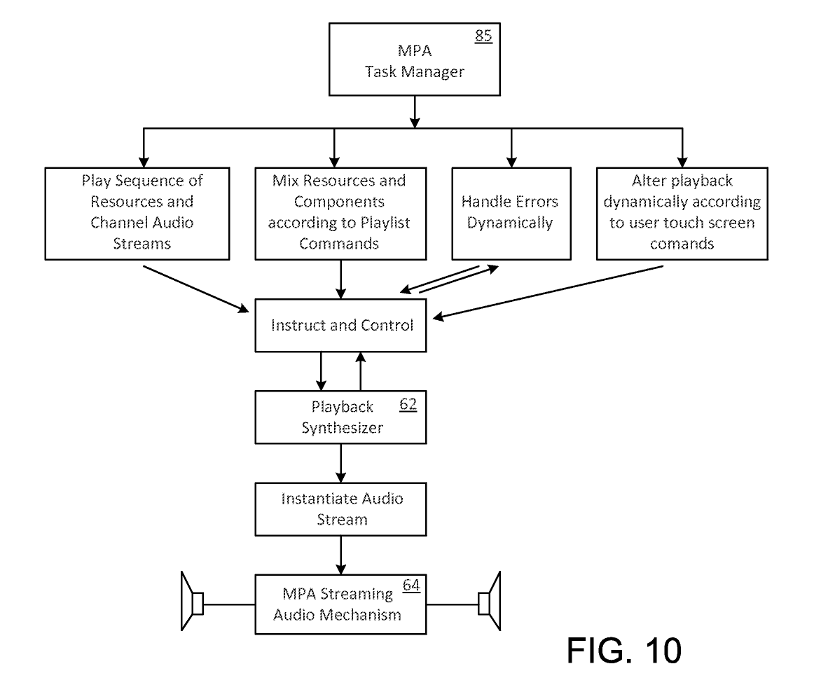

FIG. 10 shows Playback Synthesizer 62 that accepts instructions from, and is controlled by, the MPA Task Manager 85. This allows for various dynamic mixing capabilities such as, for example:
Playing back a sequence of Resources and Channel Audio Streams and mixing them together in specific ways, guided by Playlist Commands, resulting in a single stream of audio waveform data
Handling of playback errors in such a way that the resulting audio stream is continuous, seamless, and free of glitches that might be noticeable by listeners
Instantiation of the resulting audio stream in the MPA Streaming Mechanism
Control over various mixing events directly from the MPA touch screen. This capability allows for users to adjust overall stream gain, interrupt the stream with an on-location microphone announcement, trigger various Subscriber Resources to play, etc.

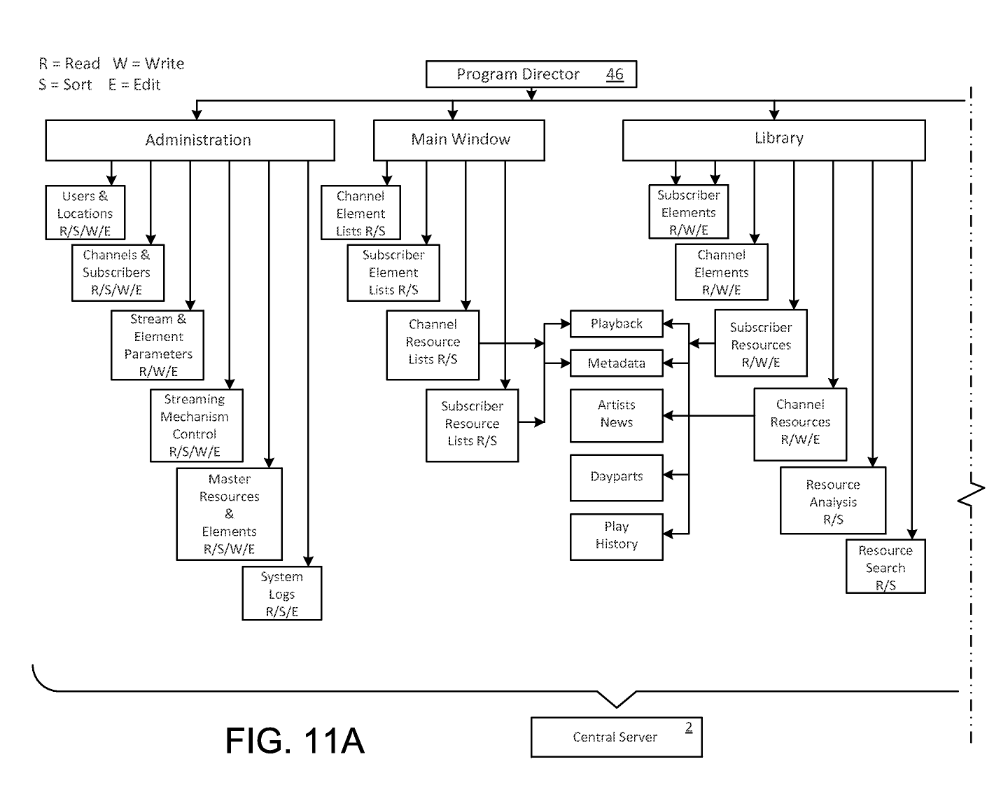

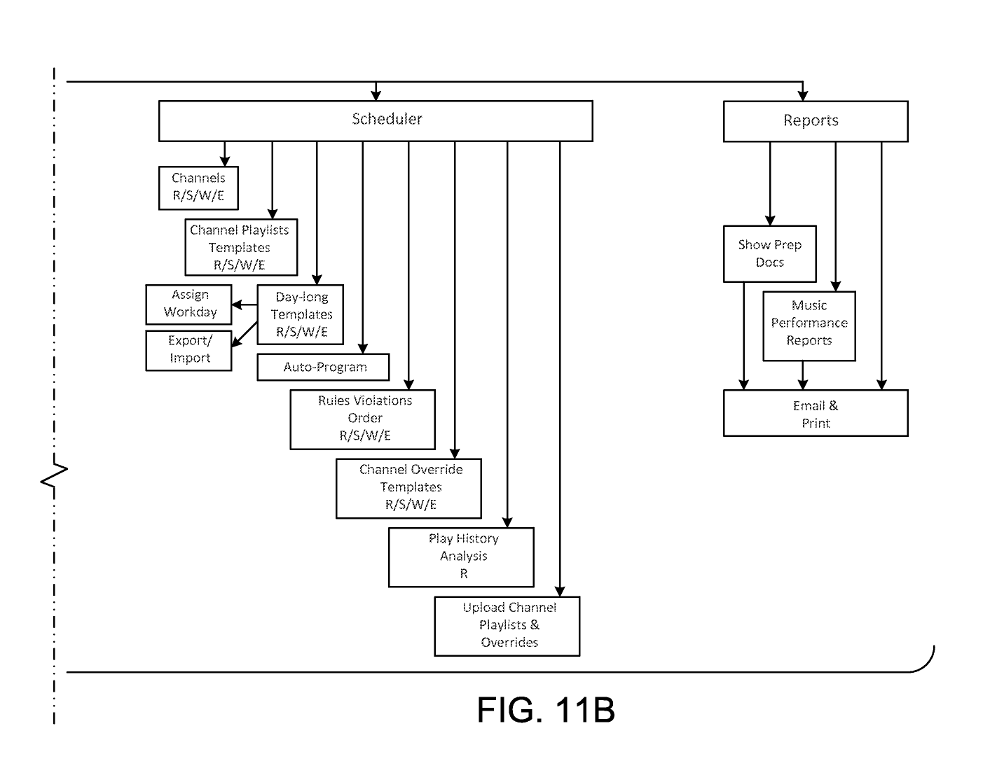

FIGS. 11A-B show the manner in which Program Director 46 communicates securely with Central Server 2, transfers Resources between a Production Facility and the Central Server 2 via Media Manager, and manipulates data in the custom database on the Central Server via the Task Manager. This ability allows for a network of simultaneous users in various physical locations that read and control one master set of data and files instead of maintaining multiple sets of data scattered across those separate locations. It is divided into five main sections:

(1) Administration, where authorized administrators can
add/edit/delete users and control those users' authorization level
define administrative locations by address and assign users to those locations
set up lists of Subscribers and assign Channels to each Subscriber
define various parameters for each Subscriber's audio stream, including the daily start and stop times, overall gain level, bandwidth throttle and mono/stereo settings
define custom gain levels for each Element for each Subscriber, which guide the Playlist Parser in generating GAIN Commands in Subscriber Playlists
set up rules for each Subscriber that guide the execution of implicit ElementRefs; for example, limiting the total number of commercials per hour to 4 for a specific Subscriber
view real-time statistics about the Central Server Streaming Mechanism including the number of instantiated audio streams, each audio stream's description, URL mount point, and bitrate, the number of currently connected MPAs, history of connected MPAs, and bandwidth use of each MPA
administer the Central Server Streaming Mechanism by instantiating, starting, stopping, resuming, and suspending audio streams
administer the list of all Channel/Subscriber Resources residing on the Central Server file system and sort by user, date-time uploaded, Channel/Subscriber/Element assignment, or any metadata item
view system logs of all actions performed on the database, including errors that occurred, and sort by user, user location, date-time, type of action, type of error, which Program Director screen the user was using when the action or error occurred, etc.
   (2) Main Window, where users can
navigate through an outline of all Channel/Subscriber Elements
navigate through a list of all Resources associated with particular Channel/Subscriber Elements in the outline
sort the Resource list by any metadata item
play/rewind/fast forward/pause/adjust volume of any selected Resource in the list
   (3) Library, where users can
add/edit/delete individual Channel/Subscriber Elements
add/edit/delete individual Channel/Subscriber Resources
assign and re-assign Resources to Elements
add batches (groups) of Channel/Subscriber Resources
add/edit Channel/Subscriber Resource metadata, which includes:
   title, artist, original artist, album, album artist, composer, publisher, label, playtime, BPM (beats per minute), genre, target demographic, age appropriateness, chart ranking, energy level, mood, vocal gender, time to first vocal entrance, lead performer, ending type, file type, bit rate, mono-stereo, UPC or other reference Codes, CD track number, overlap point, last played date and time, artwork, etc.
add/edit current news and info relating to the song or artist
assign Dayparts to Channel/Subscriber Resources
   view the entire play history of Channel/Subscriber Resources
view an analysis of the entire library according to any of the metadata categories; e.g., listing the percentages of Resources that are high vs. medium vs. low energy
search for Channel/Subscriber Resources in the library that fit particular metadata parameters or a combination of metadata parameters
play/rewind/fast forward/pause/adjust volume of Channel/Subscriber Resources
   (4) Scheduler, where users can
create Channels; e.g. Classic Rock, Country, etc.
create hour-long or other time value-calculated Channel Playlist templates, which define sequential lists of Channel/Subscriber Elements. Each template is assigned to a specific date and hour, and each Element is assigned to a specific minute and second within that hour. Each Element is also assigned a set of instructions, or “rules” to follow, that are followed by the Auto-Program function defined below. Channel Playlist templates function to support a live radio show atmosphere in various ways including:
   establishing a daily format that could involve a morning show, lunch rush, afternoon drive, etc.
   making adjustments to the daily format on specific dates to accommodate special events, holidays, etc.
group sets of hour-long or other time value-calculated Playlist templates into day-long templates
assign day-long Playlist templates to days of the week; e.g., “Monday” template
instruct Auto-Program to use the “Monday” template every Monday in the month of September, and then to switch to an alternate “Monday” template in the month of October, and so on . . . .
export/import saved Playlist templates to/from other users
use the Auto-Program function to choose Channel Resources for each Channel Element in each empty Channel Playlist template. The Auto-Program function intelligently chooses the best Resource for each Element, according to the assigned rules, as it traverses the template sequence; e.g., it might choose the most popular Beatles' song from 1969 that was in the top 25 of that year, has medium tempo, is psychedelic, has approximately a 4 minute 30 second playtime, is suitable for ages above 12 years, and is suitable to be played between 10 am and noon on a Thursday. In another instance, it might choose a News Resource to play precisely at 6:30 pm on a Monday. In yet another instance, it might choose to allot a 24 second gap between Resources for a DJ to make a live announcement. The Auto-Program function ensures that the sum of the playtimes (adjusting for overlaps) of all Resources chosen for a given Playlist template equals 60 minutes.
set up a custom “rules violations order” that defines a hierarchy of rules on a scale from “least important” to “most important.” As Auto-Program chooses Resources for any given Element, it faces the possibility that it might find 0 Resources that fit the set of assigned rules. In this case, the “rules violations order” guides it through a series of “relaxing of rules” starting with the least important rule on up to the most important rule. Once a Resource is found that fits a relaxed set of rules, the user is notified which rules were broken in order to find the most appropriate Resource.
order Auto-Program to make a different choice for any Resource that it previously chose, and to abide by the same set, or a new set, of rules in making that new choice.
set up Channel Playlist Override templates for any Subscriber that requires Playlists that deviate from the Channel Playlist templates. For each hour-long or other time value-calculated Channel Playlist template, the user can add/edit/delete/change the order of any and all Elements for each individual Subscriber. The Auto-Program function generates one Channel Playlist Override per specified Subscriber in addition to the parent Channel Playlist.
view an analysis of the play history, per Channel, of every Channel/Subscriber Element and its associated Resources over a certain period of time; e.g. the last week, the last year, etc. For each Element, various data is given: how many times an associated Resource was chosen to play, the average playtime of those chosen Resources, the average number of times any single one of those Resources was repeated per week, the span of time in between each repeat, the average number of times an associated Resource played on a per-hour basis, the relationship between the number of times the Element was scheduled and the total number of all scheduled Elements expressed as a percentage, etc.
upload Channel Playlists (via Media Manager) to the Central Server. Channel Playlists provide various pieces of information that the Central Server Playlist Parser needs in order to execute its tasks.
upload Channel Playlist Overrides (via Media Manager) to the Central Server
   (5) Reports, where users can,
print “show preparation” documents for any scheduled Playlists. When the user prints these documents, the Report Compiler traverses the selected Playlists and prepares a full color text document. This document provides the on-air personalities with information about the Resources that are playing during each hour, including all of the metadata items listed in the Library section (described above).
print music performance reports for the Performing Rights Agencies that include the required account information such as account name, account number, submitter type, program type, reporting period, etc.

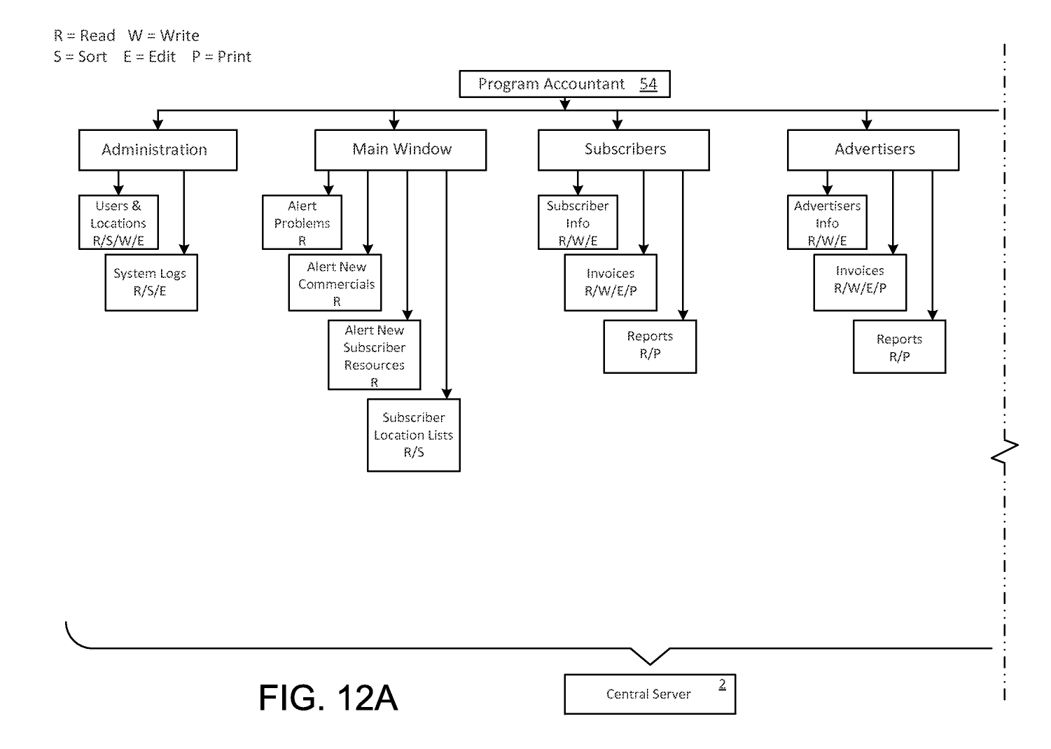

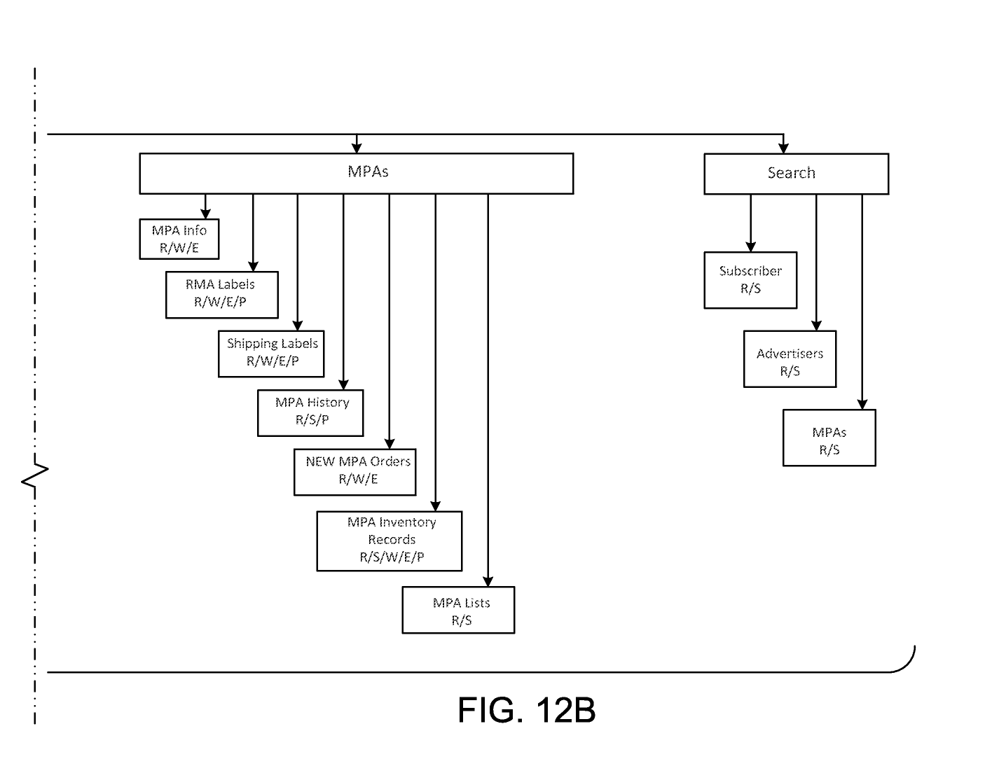

FIGS. 12 A-B show how Program Accountant 54 communicates securely with Central Server 2, transfers files between a Production Facility and the Central Server, and manipulates data in the custom database on the Central Server via the Central Server Task Manager 30. This ability allows for a network of simultaneous users in various physical locations that read and control one master set of data and files instead of maintaining multiple sets of data scattered across those separate locations. It is divided into six main sections:

(1) Administration, where authorized administrators can
add/edit/delete users and control those users' authorization level
define administrative locations by address and assign users to those locations
view system logs of all actions performed on the database, including errors that occurred, and sort by user, user location, date-time, type of action, type of error, which Program Accountant screen the user was using when the action or error occurred, etc.

(2) Main Window, where users can
be alerted about time-sensitive issues and problems, such as
   dropped MPA connections
   MPAs that were shipped but have not been installed at the destined business establishment in a reasonable amount of time
   MPAs that were authorized for return but have not arrived at the repair center in a reasonable amount of time
   Contracts with Subscribers that are nearing termination date
   Errors occurring anywhere in the System
be alerted to new Commercial air time purchases and file uploads by Advertisers
be alerted to new Subscriber Resource change requests such as Promos, Phone Interviews, etc.
view sets and subsets of individual Subscriber locations according to particular criteria, such as
   type of business (retail, fitness, salon, grocery, etc.)
   demographic
   have dropped MPA connections
   have been shipped MPAs but have not installed those MPAs in a reasonable amount of time
   have no MPAs in their possession
   have authorized MPA returns that are overdue to arrive at the repair center in a reasonable amount of time
   have contracts that are nearing termination date
   have contracts with advertisers or sponsors
   are the headquarters or administrative offices for a group of franchises
   are a franchise that is subordinate to a central headquarters and do not receive invoices and reports directly

(3) Subscribers, where users can
add/edit/delete user information (described above)
print periodic invoices for Subscribers
print reports about Subscriber Resources

(4) Advertisers, where users can
add/edit/delete advertiser information (described above)
print periodic invoices for Advertisers
print reports detailing the play history of Commercials

(5) MPAs, where users can
add/edit/delete user information (described above)
print RMA labels for MPA returns
print shipping labels for deployed MPAs
view history of an MPA's locations, conditions, RMAs, etc.
make new MPA orders
manage the MPA inventory records
view sets and subsets of MPAs according to particular criteria, such as

(6) Search, where users can
search for user information
search for and view MPAs by various categorizations such as
   all MPAs assigned to a regional franchise
   a single MPA
   all MPAs that have dropped off the network
   all MPAs that are due for return (assigned an RMA)
   all MPAs that are due for installation at a business establishment

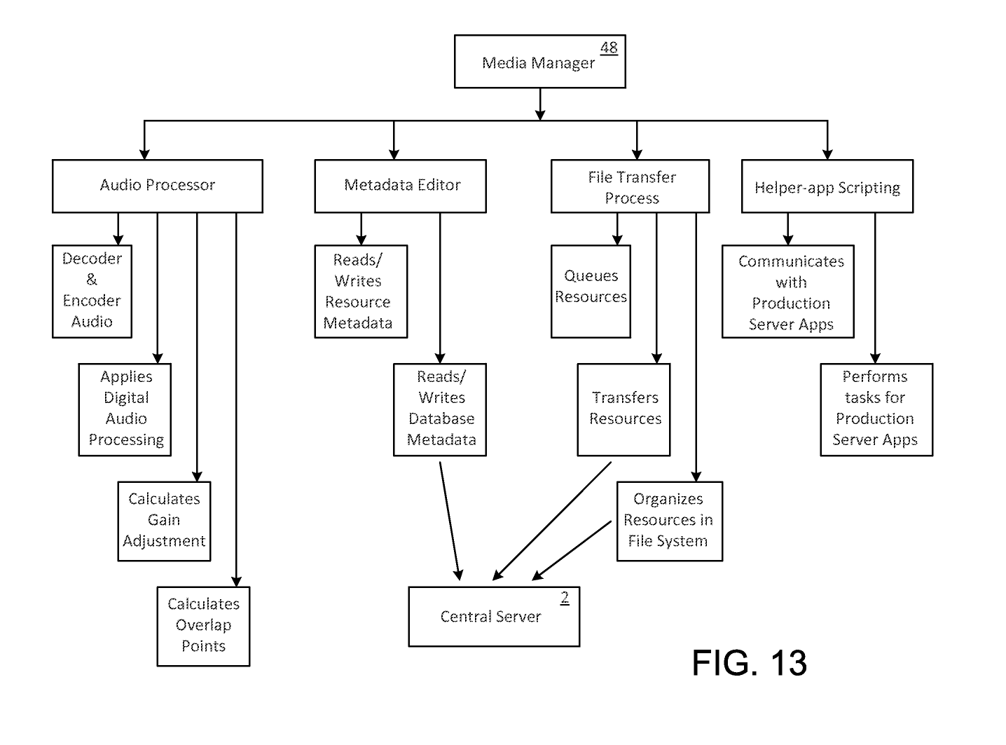

Media Manager 48 that is shown in FIG. 13 provides a capability to communicate securely with the Central Server 2, transfer files between a Production Facility and the Central Server 2, and manipulate data in the custom database on the Central Server 2 via the Central Server Task Manager 30. Media Manager may be a desktop application for working with media libraries, and can be divided into four main sections:

(1) An audio processor
decodes and encodes audio waveform data and allows users to convert one audio file format to another file format; e.g. an AIFF-encoded file to an Ogg Vorbis-encoded file, or a WAV-encoded file into an FLAC-encoded file
applies compression, limiting, EQ, and other digital audio processes to Resources
calculates gain adjustment on audio files in relation to a standard “unity” gain level for all Resources residing in the Central Server data storage mechanism and database
calculates overlap points for Resources to be employed during stream and Component assembly
   (2) A metadata editor
reads/writes metadata from/to Resources
reads/writes metadata from/to the Central Server Database via the Central Server Task Manager 30
   (3) A file transfer process
transfers Resources between a Production Facility and the Central Server
manages bandwidth limitations by utilizing a Resource transfer queue, whereby Resources are prioritized by playtime urgency and queued accordingly.
organizes Resources in the Central Server file system (described above)
   (4) A helper-application scripting language
communicates with other Production Facility applications via its scripting interface
performs tasks listed in 1-3 above on behalf of other Production Facility applications

It will be understood that the various components, elements and functional blocks described herein can be implemented in software, firmware, hardware, or a combination thereof. When all or portions of the system are implemented in software, for example as an executable program, the software may be executed by a general purpose computer (such as, for example, a personal computer that is used to run a variety of applications), a specialized computer (such as a server), or by various other devices such as the MPA. When implemented in hardware, the hardware may be incorporated into a single enclosure or may be incorporated into multiple units that may or may not be co-located at a single location. Distributed hardware and software configurations associated with the Internet are known in the art and in the interests of brevity will not be elaborated upon herein.

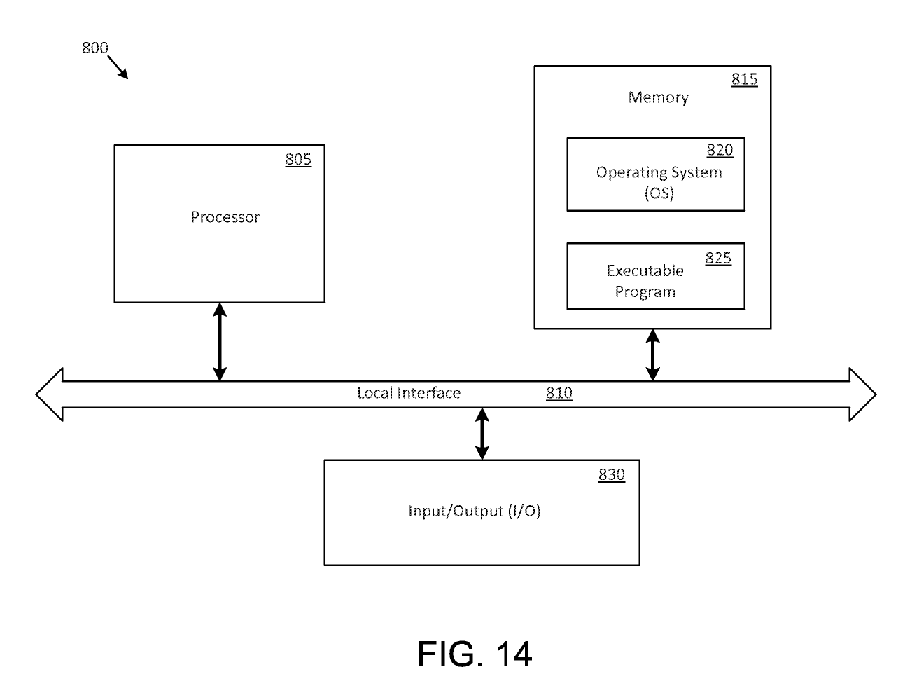

FIG. 14 shows a few basic elements of computer system 800 that may be used to implement various functional elements described herein. These functional elements include a processor 805, memory 815, and one or more input and/or output (I/O) devices 830 (or peripherals) that are communicatively coupled via a local interface 810. The local interface 810 can be, for example, metal tracks on a printed circuit board, or any other forms of wired, wireless, and/or optical connection media. Furthermore, the local interface 810 is a symbolic representation of several elements such as controllers, buffers (caches), drivers, repeaters, and receivers that are generally directed at providing address, control, and/or data connections between multiple elements.

The processor 805 is a hardware device for executing software, more particularly, software stored in memory 815. The processor 805 can be any commercially available processor or a custom-built device. Examples of suitable commercially available microprocessors include processors manufactured by companies such as Intel, AMD, and Motorola.

The memory 815 can include any type of one or more volatile memory elements (e.g., random access memory (RAM, such as DRAM, SRAM, SDRAM, etc.)) and nonvolatile memory elements (e.g., ROM, hard drive, tape, CDROM, etc.). The memory elements may incorporate electronic, magnetic, optical, and/or other types of storage technology. It must be understood that the memory 815 can be implemented as a single device or as a number of devices arranged in a distributed structure, wherein various memory components are situated remote from one another, but each accessible, directly or indirectly, by the processor 805.

The software in memory 815 may include one or more separate programs, each of which comprises an ordered listing of executable instructions for implementing logical functions. In the example of FIG. 8, the software in the memory 815 includes an executable program 825 that can be executed to implement one or more elements in accordance with the present invention. Memory 815 further includes a suitable operating system (OS) 820. The OS 820 can be an operating system that is used in various types of commercially-available devices such as, for example, a personal computer running a Windows® OS, Linux® OS, an Apple® product running an Apple-related OS, or an Android OS running in a smart phone. The operating system 820 essentially controls the execution of executable program 825 and also the execution of other computer programs, such as those providing scheduling, input-output control, file and data management, memory management, and communication control and related services.

Executable program 825 is a source program, executable program (object code), script, or any other entity comprising a set of instructions to be executed in order to perform a functionality. When a source program, then the program may be translated via a compiler, assembler, interpreter, or the like, and may or may not also be included within the memory 815, so as to operate properly in connection with the OS 820.

The I/O devices 830 may include input devices, for example but not limited to, a keyboard, mouse, scanner, microphone, etc. Furthermore, the I/O devices 830 may also include output devices, for example but not limited to, a printer and/or a display. Finally, the I/O devices 830 may further include devices that communicate both inputs and outputs, for instance but not limited to, a modulator/demodulator (modem) for communicatively coupling a device located in a business subscriber location (an MPA for example,) to a wide area network such as the Internet.

If the computer system 800 is a PC, workstation, or the like, the software in the memory 815 may further include a basic input output system (BIOS) (omitted for simplicity). The BIOS is a set of essential software routines that initialize and test hardware at startup, start the OS 820, and support the transfer of data among the hardware devices. The BIOS is stored in ROM so that the BIOS can be executed when the computer system 800 is activated.

When the computer system 800 is in operation, the processor 805 is configured to execute software stored within the memory 815, to communicate data to and from the memory 815, and to generally control operations of the computer system 800 pursuant to the software. The software stored within the memory 815, in whole or in part, but typically the latter, is read by the processor 805, perhaps buffered within the processor 805, and then executed.

When implemented in software, as is shown in FIG. 8, it should be noted that the software can be stored on any computer readable storage medium for use by, or in connection with, any computer related system or method. In the context of this document, a computer readable storage medium is an electronic, magnetic, optical, or other physical device or means that can contain or store a computer program for use by, or in connection with, a computer related system or method.

The software can be embodied in any computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable storage medium” can be any means that can store, communicate, propagate, or transport the program for use by or in connection with the instruction execution system, apparatus, or device. The computer readable storage medium can be, for example but not limited to, an electronic, magnetic, optical, electromagnetic, infrared, or semiconductor system, apparatus, or device. More specific examples (a non-exhaustive list) of the computer-readable storage medium would include the following: a portable computer diskette, a random access memory (RAM), a read-only memory (ROM), an erasable programmable read-only memory (EPROM, EEPROM, or Flash memory) an optical disk such as a DVD or a CD.

In an alternative embodiment, where one or more of the elements described herein are implemented in hardware, the hardware can include any one, or a combination, of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc

The disclosure of each document cited (including patents or other disclosures) in the Background, Summary, Detailed Description, and list of References is herein incorporated by reference in its entirety.

It is to be understood that the disclosures are not limited to particular embodiments, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

Although any devices, methods and materials similar or equivalent to those described herein can be used to practice/provide the products, methods and systems of the present disclosure, exemplary appropriate products, materials and methods are described herein.

A number of embodiments of the disclosure have been described. Nevertheless, it will be understood that various modifications may be made without departing from the spirit and scope of the present disclosure. Accordingly, other embodiments are within the scope of the following claims.

What is claimed is:

1. A system comprising:
a data storage system having stored thereon at least a first and a second radio commercial; and
a server system configured to:
retrieve the first and the second radio commercials from the data storage system,
generate a customized first playlist comprising the first radio commercial and one or more songs, the customized first playlist explicitly tailored for a first business subscriber,
generate a customized second playlist comprising the second radio commercial and one or more songs, the customized second playlist explicitly tailored for a second business subscriber,
transmit, through a network, to at least one business location of the first business subscriber, a first streaming radio broadcast comprising the customized first playlist, and
transmit, through the network, to at least one business location of the second business subscriber, a second streaming radio broadcast comprising the customized second playlist.

2. The system of claim 1, further comprises inserting into at least one of the first or the second streaming radio broadcasts, one or more audio interludes originated by one or more radio show hosts.

3. The system of claim 2, wherein a portion of the at least one of the first or the second streaming radio broadcasts is a pre-recorded radio segment, and wherein the one or more audio interludes are inserted into the at least one of the first or the second streaming radio broadcasts along with the pre-recorded radio segment in one of a) a real-time mode or b) a near real-time mode.

4. The system of claim 3, wherein the network is the Internet.

5. The system of claim 4, wherein the one or more radio show hosts comprises a first radio show host that originates a plurality of audio interludes over a period of time whereby a listener of one of the first or the second streaming radio broadcasts associates the first radio show host with a respective one of the first or the second streaming radio broadcasts.

6. The system of claim 5, wherein associating the first radio show host with a respective one of the first or the second streaming radio broadcasts is part of a branding operation directed to a targeted business demographic of a respective one of the first or the second business subscriber.

7. The system of claim 6, wherein a cost of the branding operation is borne by at least one of: a) a commercial entity, b) a non-commercial entity, or c) an individual entity.

8. The system of claim 4, wherein at least one of the customized first playlist or the customized second playlist is at least one of: a) a channel playlist, or b) a subscriber playlist.

9. The system of claim 8, wherein the channel playlist is operative as a template for the subscriber playlist.

10. The system of claim 9, wherein the subscriber playlist inherits one or more components of the channel playlist.

11. The system of claim 10, wherein the one or more components of the channel playlist comprises at least one of: a) a reference to a channel resource or b) a reference to a channel element.

12. The system of claim 11, wherein the channel resource is an audio file and the channel element identifies a family of channel resources.

13. The system of claim 4, wherein the data storage system comprises a plurality of data storage devices, and further wherein the server system comprises a plurality of servers, the plurality of servers including a first server uniquely identifiable by a first Uniform Resource Locator (URL) that is used to access the first server from a first business location and download the streaming customized radio broadcast to the first business location.

14. The system of claim 13, wherein the plurality of servers further includes a second server uniquely identifiable by a second URL that is used to access the second server from a second business location and download the streaming customized radio broadcast to the second business location.

15. The system of claim 13, wherein the plurality of servers are located at a plurality of geographically dispersed locations and the plurality of data storage devices are collectively located at a first geographic location.

16. The system of claim 13, wherein the plurality of servers are located at a first plurality of geographically dispersed locations and the plurality of data storage devices are located at a second plurality of geographically dispersed locations.

17. The system of claim 16, wherein at least one location in the first plurality of geographically dispersed locations is the same as another one location in the second plurality of geographically dispersed locations.

18. A device comprising:
an input-output interface for communicatively coupling the device to a network and receiving therefrom, a customized streaming radio broadcast comprising a customized playlist that includes at least one radio commercial and one or more songs, the customized playlist explicitly tailored for a first business subscriber; and
a processor configured to process and convert the customized streaming radio broadcast into an audio signal that is reproducible through a speaker system located in at least one business location of the first business subscriber.

19. The device of claim 18, wherein the network is the Internet, and further wherein receiving the customized streaming radio broadcast comprises using a Uniform Resource Locator (URL) to couple the device to a server that is configured to provide the customized streaming radio broadcast to the device.

20. The device of claim 19, wherein the customized streaming radio broadcast further comprises one or more audio interludes originated by one or more radio show hosts.

21. The device of claim 20, wherein the one or more audio interludes are inserted into the customized streaming radio broadcast along with at least one pre-recorded song in one of a) a real-time mode or b) a near real-time mode.

22. The device of claim 20, wherein the one or more radio show hosts includes a first radio show host that originates a plurality of audio interludes over a period of time whereby one or more listeners at a first business location associate the first radio show host with the customized streaming radio broadcast.

23. The device of claim 22, wherein associating the first radio show host with the customized streaming radio broadcast is part of a branding operation selected on the basis of the first business location.

24. A system comprising:
a first plurality of receiving devices located at a first business establishment location, each of the first plurality of receiving devices configured to receive a first streaming customized radio broadcast by using a first Uniform Resource Locator (URL) that uniquely identifies a first server configured to provide the first streaming customized radio broadcast to each of the first plurality of receiving devices, the first streaming customized radio broadcast comprising a first plurality of radio commercials explicitly targeting the first business establishment location on the basis of a differentiation between the first business establishment location and a second business establishment location.

25. The system of claim 24, further comprising:
at least one second receiving device located at the second business establishment location, the at least one second receiving device configured to receive a second streaming customized radio broadcast by using a second URL that uniquely identifies a second server configured to provide the second streaming customized radio broadcast to the at least one second receiving device, the second streaming customized radio broadcast comprising a second plurality of radio commercials explicitly targeting the second business establishment location on the basis of the differentiation between the first business establishment location and the second business establishment location.

26. The system of claim 25, wherein the first server is the same as the second server.

27. The system of claim 25, wherein at least one of the first or the second streaming customized radio broadcasts further comprises one or more audio interludes originated by one or more radio show hosts.

28. The system of claim 27, wherein the one or more audio interludes are inserted into the at least one of the first or the second streaming customized radio broadcasts along with at least one pre-recorded song in one of a) a real-time mode or b) a near real-time mode.

29. The system of claim 27, wherein the one or more radio show hosts includes a first radio show host that originates a plurality of audio interludes over a first period of time whereby one or more listeners at the first business establishment location associate the first radio show host with the first streaming customized radio broadcast.

30. The system of claim 29, wherein associating the first radio show host with the first streaming customized radio broadcast is part of a branding operation selected on the basis of the first business establishment location.

31. The system of claim 29, wherein the one or more radio show hosts includes a second radio show host that originates a second plurality of audio interludes over a second period of time whereby one or more listeners at the second business establishment location associate the second radio show host with the second streaming customized radio broadcast.

32. The system of claim 31, wherein the first radio show host is the same as the second radio show host and wherein at least a portion of a content of the first streaming customized radio broadcast is different than the second streaming customized radio broadcast, the portion of the content selected on the basis of the differentiation between the first business establishment location and the second business establishment location.

33. The system of claim 27, wherein the one or more radio show hosts includes a first radio show host and a second radio show host, wherein the first radio show host originates a first plurality of audio interludes over a first period of time whereby one or more listeners at the first business establishment location associate the first radio show host with a first segment of the first streaming customized radio broadcast, and further wherein the second radio show host originates a second plurality of audio interludes over a second period of time whereby the one or more listeners at the first business establishment location associate the second radio show host with a second segment of the first streaming customized radio broadcast.
